(19) United States
(12) Patent Application Publication
(10) Pub. No.: US 2005/0231716 A1
(43) Pub. Date: Oct. 20, 2005

(54) Apparatus and method for measuring water quality using image data

(75) Inventors: Min-Su Ryu, Kwangju (KR); Jong-Ho Park, Kangjin-gun (KR)

Correspondence Address: GREENBLUM & BERNSTEIN, P.L.C., 1950 ROLAND CLARKE PLACE, RESTON, VA, 20191, US

(73) Assignees: ISTEK, Inc., Seoul (KR); Bock-Young WHANG, Seoul (KR)

(21) Appl. No.: 11/083,939

(22) Filed: Mar. 21, 2005

Related U.S. Application Data
(63) Continuation-in-part of application No. PCT/KR03/01770, filed on Aug. 30, 2003.

(30) Foreign Application Priority Data
Sep. 19, 2002 (KR) 10-2002-0057356
Aug. 29, 2003 (KR) 10-2003-0060302

(51) Int. Cl. G01N 21/00

(52) U.S. Cl. 356/318; 356/337

(57) ABSTRACT

The present invention relates to an apparatus and method for measuring a water quality using an image data that are capable of accurately measuring a water quality of a sample in such a manner that an image data included in an image obtained by taking a sample used to measure a water quality such as turbidity, COD, pollutant, etc. using a photographer is compared with an image data of a standard sample that is previously computed and stored. There are provided a certain shaped casing for preventing an input of an external light, a certain shaped casing capable of preventing an input of an external light, a sample holder which is installed in one side of the casing and is capable of holding the sample inserted therein, a light source which is positioned near the sample holder and is adapted to supply a light to the sample holder, a photographing unit adapted to photograph the sample in the sample holder to which the light is projected for thereby forming an image, a relational computation unit adapted to compare the image data included in the image photographed by the photographing unit with the previously stored image data of the standard sample and to compute a water quality value of the sample, a display unit adapted to display the water quality value of the sample computed by the relational computation unit on a screen, and a control unit adapted to control the flow of various data.

### CROSS-REFERENCE TO RELATED APPLICATIONS

This application is a continuation-in-part of International Application No. PCT/KR2003/001770, filed Aug. 30, 2003, the contents of which are herein incorporated by reference in its entirety.

This application is also related to Korean Application Nos. 10-2002-0057356, filed Sep. 19, 2002, and 10-2003-0060302, filed Aug. 29, 2003, the contents of both are herein incorporated by reference in their entireties.

### BACKGROUND OF THE INVENTION

1. Field of the Invention

The present invention relates to an apparatus and method for measuring a water quality using an image data, and in particular to an apparatus and method for measuring a water quality using an image data that are capable of accurately measuring a water quality of a sample in such a manner that an image data included in an image obtained by taking a sample used to measure a water quality such as turbidity, COD (Chemical Oxygen Demand), pollutant, etc. using a photographer is compared with an image data of a standard sample that is previously computed and stored.

2. Description of the Background Art

As an industry is advanced, environment pollution is a big problem in the modern society. Among the above environment pollutions, a water pollution problem is wide and continuous. In order to prevent a certain damage due to water pollution, it is needed to measure the degree of the water pollution.

As a method for measuring a turbidity, which is one of the water pollutions, there are a transmitted light method, a surface scattering light method, and a transmitted scattering light method.

In the transmitted light method, there is a method in which when a sample water flowing through a flow cell is scanned by a light beam from a light source, the light transmitted a certain fluid is received by a photoelectricity converter, and the converted voltage is reconverted into a turbidity value.

In the scattering light method, there is a method in which when a sample water flowing through a flow cell is scanned by a light beam from a light source, a light scattered by a corpuscle in a fluid is received by a photoelectricity converter, and the converted voltage is reconverted into a turbidity value.

In the surface scattering light method, there is a method in which when a surface of a sample water is not scanned through a flow cell, but is canned by a light beam from a light source, the light scattered by a corpuscle near a surface of a water sample is received by a photoelectricity converter, and the converted voltage is reconverted into a turbidity value.

In the transmitted scattered light method, the value obtained by dividing the scattered light intensity with the transmitted light intensity is reconverted into a turbidity value.

In the above-described turbidity measuring methods, since there is a distortion phenomenon of a scattered light inputted into a sample, it is impossible to stably measure an accurate turbidity below 0.1.

In addition, there are the problems that a COD, various pollutants, etc. by which it is possible to check water pollution state should be measured using a dedicated measuring apparatus, and it is needed to visually check the polluted states.

### SUMMARY OF THE INVENTION

Accordingly, it is an object of the present invention to provide an apparatus and method for measuring a water quality using an image data that overcome the problems countered in the conventional art.

It is another object of the present invention to provide an apparatus and method for measuring a water quality using an image data capable of accurately measuring water quality of a sample in such a manner that an image data included in an image obtained by taking a sample used for measuring water quality such as a turbidity, COD, pollutant, etc. using a photographer is compared with an image data of a previously computed and stored standard sample.

It is further another object of the present invention to provide an apparatus and method for measuring a water quality using an image data capable of obtaining the same water quality data with respect to the same samples in such a manner that an image is photographed in a state that a light amount and scanning angle are uniform by fully blocking a sample from the outside.

To achieve the above objects, there is provided a method for measuring water quality using an image data (concerning turbidity, COD (Chemical Oxygen Demand), and various ions, a method for measuring water quality using an image, comprising: a step for positioning a test sample at a sample holder for measuring a water quality using the test sample; a step for transmitting light into the test sample in a state that a penetration of an external light is blocked; a step for photographing the image of the test sample as an image; a step for computing the image data included in the photographed image of the test sample using the image data of the previously computed and stored standard test sample and one method selected among a regression analysis method, optimization technique, artificial neuron system, fuzzy, neuron fuzzy, etc. or a certain technique derived from the above methods for thereby computing a water quality of the test sample using a result of the above computation; and a step for computing the water quality value of the standard test sample having the same image data as the test sample as a water quality value of the test sample.

In addition, there is further provided a pre-process step of the sample in such a manner that the sample has a certain color for measuring water quality with respect to COD and various ions of the sample.

To achieve the above objects, there is provided an apparatus for measuring water quality using an image data, concerning turbidity, COD (Chemical Oxygen Demand), and various ions and displaying the measured water quality value on a screen, an apparatus for measuring water quality using an image, comprising: a certain shaped casing capable of preventing a penetration of an external light; a sample holder that is installed at one side of the casing for receiving a test sample therein; a light source that is positioned near the sample holder for supplying a light; a photographing unit adapted to photograph the light transmitted from the sample holder as an image signal; a relational computation unit adapted to compute a relationship with an image data of the previously stored standard sample from the image data contained in the image photographed by the photographing unit based on a certain method selected among a regression analysis method, optimization technique, artificial neuron system, fuzzy, neuron fuzzy, etc. or a certain technique derived from the above methods for thereby computing a water quality of the test sample; and a controller for controlling the flows of various data.

Preferably, the light source unit uses one or more than one light source, and the light source is selected among white color light, visible light, infrared ray, ultraviolet ray and laser.

The photographing unit is installed vertically with respect to the light source unit.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic view illustrating a water quality measuring apparatus using an image data according to an embodiment of the present invention;

FIG. 2 is a block diagram illustrating a water quality measuring apparatus using an image data according to an embodiment of the present invention;

FIG. 3 is a view illustrating an example of a database according to an embodiment of the present invention;

FIGS. 4A through 4C are graphs illustrating an intensity of a pixel included in a measured image according to an embodiment of the present invention; and

FIGS. 5A through 5C are the calibration graphs of FIGS. 4A through 4C according to the present invention.

### DETAILED DESCRIPTION OF THE PREFERRED EMBODIMENTS

The constructions of the apparatus for measuring a water quality using an image data according to the present invention will be described with reference to the accompanying drawings.

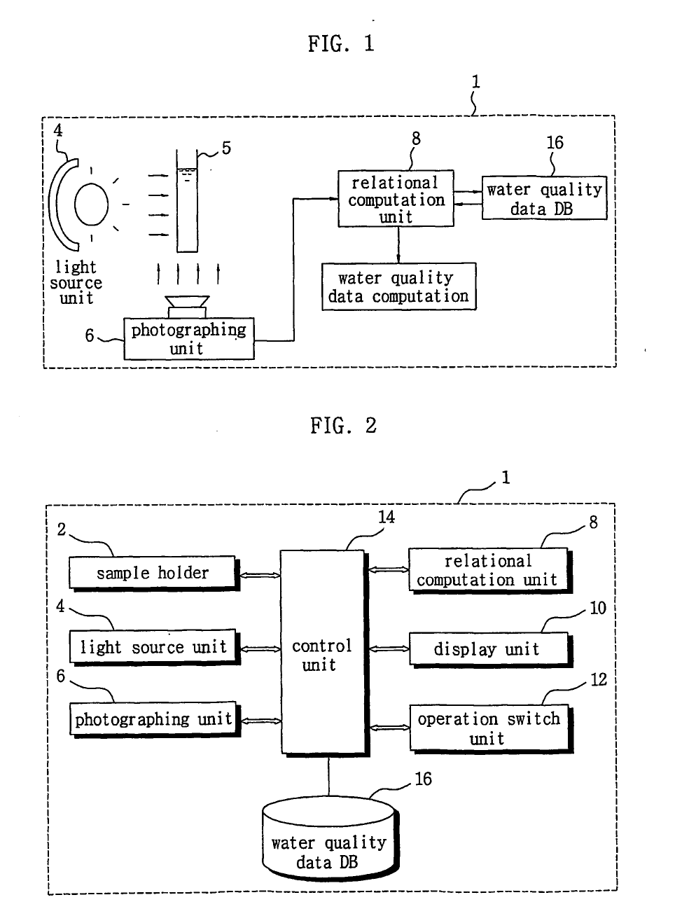

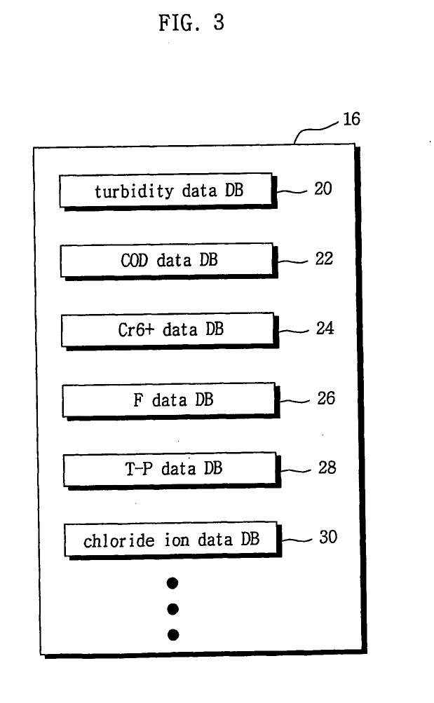

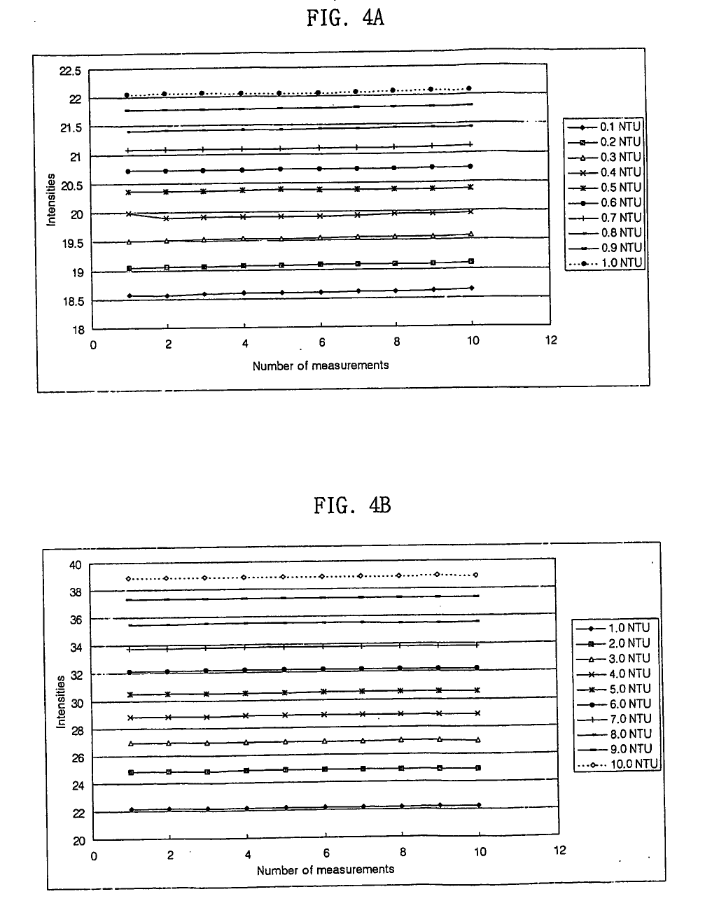

FIG. 1 is a schematic view illustrating a water quality measuring apparatus using an image data according to an embodiment of the present invention, FIG. 2 is a block diagram illustrating a water quality measuring apparatus using an image data according to an embodiment of the present invention, and FIG. 3 is a view illustrating an example of a database according to an embodiment of the present invention.

As shown in FIGS. 1 and 2, a water quality measuring apparatus 1 according to the present invention is formed in a box shaped casing, which may be formed in various constructions such as a hexahedron, etc. A sample 5 is positioned in the interior of the casing for measuring various water quality values. An image data is obtained by photographing in a state that light is transmitted to the sample 5. Thereafter, an image data included in the image of the sample and an image data of a previously measured standard sample are compared, so that a standard sample having the image data same as the sample 5 is searched for thereby computing the value of the water quality of the sample 5. At this time, the inner sides of the casing is coated with a lusterless black color material for thereby preventing the light transmitted through the sample from being scattered by a certain material except for the samples.

As shown in FIG. 2, the water quality measuring apparatus using an image data will be described. In the interior of the water quality measuring apparatus 1, there are provided a sample holder 2, a light source unit 4, a photographing unit 6, a relational computation unit 8, and a control unit 14. On the surface of the water quality measuring apparatus, there are provided a display unit 10, and various operation switch units 12.

The sample holder 2 is installed near the light source so that the light from the light source unit 4 is directly outputted to the sample 5 after a sample is provide for thereby measuring various water quality states. When the sample 5 is provided in the sample holder 2, the sample holder 2 is covered so that a light except for the light from the light source is not inputted. At this time, the sample holder 2 is formed in a batch construction for implementing a uniform distribution of the sample 5.

In the sample 2, a preprocess should be processed for visually checking a water quality with respect to the factors such as COD(Chemical Oxygen Demand), Cr⁶⁺, F, T-P, Cl⁻, peroxide, chloride, Fe, T-N, nitric acid nitrogen, ABS, sulfuric acid ion, phenol, cyanogen, chrome, zinc, copper, cadmium, lead, arsenic, nickel, trihalomethane, etc. For example, in order to measure COD, a preprocess is performed in a sequence that H₂SO₄ and Ag₂SO₄ are added to the sample, and KmnO₄ is added and heated. Thereafter, Na₂C₂O₄ is mixed, and KMnO₄ is drop-added. In addition, Cr⁶⁺ needs a certain preprocess that H₂SO₄ is added to a sample and is cooled to 15C, and then a diphenylcarbazide is injected. In addition, F needs a preprocess that a phenolphthalein ethyl alcohol solution is added to a sample and a sodium hydroxide is added and concentrated, and a silicon dioxide, phosphoric acid, and perchlorate are added and distilled, and a resultant mixture is provided in a La Alizarin Complexon and is left alone for one hour. When the ions are colored by a coloring agent in the above manner, the photographing unit takes a photo with respect to the colored state, so that it is possible to obtain an image in which particles is exposed.

The light source unit 4 is installed in such a manner that the light from the light source unit 4 is inputted to the sample holder 2. A common visible ray, infrared ray, ultraviolet ray, laser, etc. are used as a light source. In the case of the common sample, a laser having a relationally high transmissivity is used, and in the case of the sample, which needs an extinction degree like T-P, UV is generally used.

In addition, in the light source unit, more than at least one light source are sequentially installed so that the sample holder has the same illumination intensities based on the light outputted to the sample holder. Namely, in the case that one light source is used, since the light is not transmitted to the relationally smaller particles covered by the larger particles among the particles of the sample, the light may not be inputted into the photographed screen. In the case that multiple light sources are used, since the particles are not positioned on the straight line with respect to the light source, it is possible to prevent that the problem that the light is not transmitted through the particles because the smaller particles are covered by the larger particles. Therefore, it is possible to obtain a desired image formed based on the particles transmitted to the sample.

The photographing unit 6 includes a photographing apparatus provided near the sample 2 for image-capturing the sample 5 formed as the light from the light source is projected. The digital camera, CCD, image camera, camcorder, etc. may be used as the photographing apparatus 6. The common camera is designed to convert an image captured by an A/D converter into a digital data. The above photographing unit 6 is installed to have an angle of about 45° through 90° in such a manner that the photographing unit 6 is not affected by other light except for the light projected to the sample 5. In particular, preferably, the photographing unit 6 is installed to have an angle of 90° C. with respect to the light source.

The relational computation unit 8 receives an image of a sample photographed by the photographing unit 6 and compares the image data included in the image with an image data of a standard sample stored in the water quality data DB 16 for thereby computing a water quality data of the sample 5.

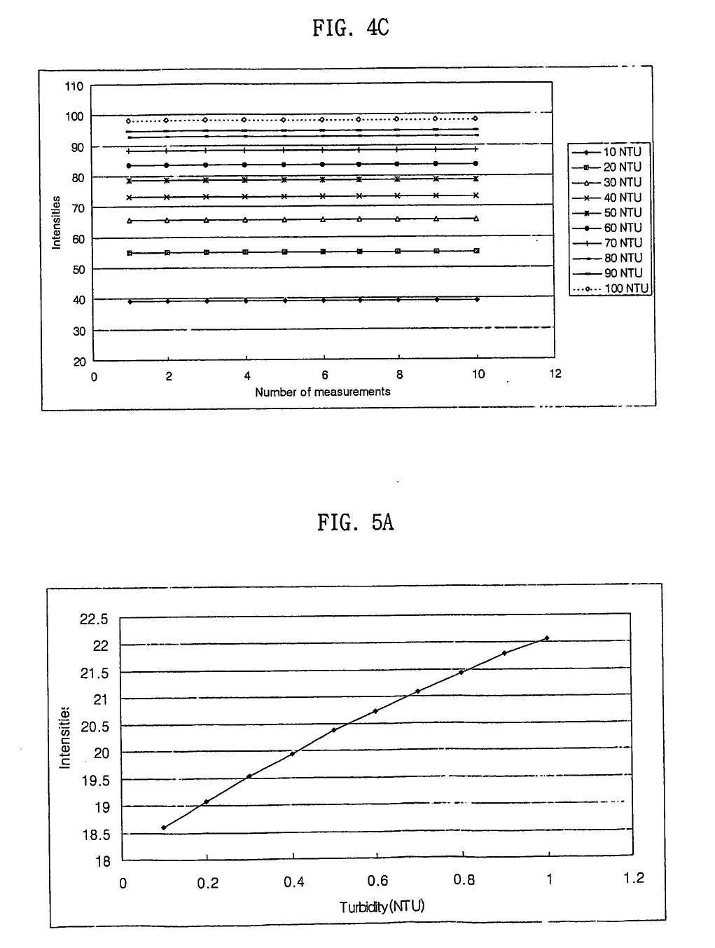

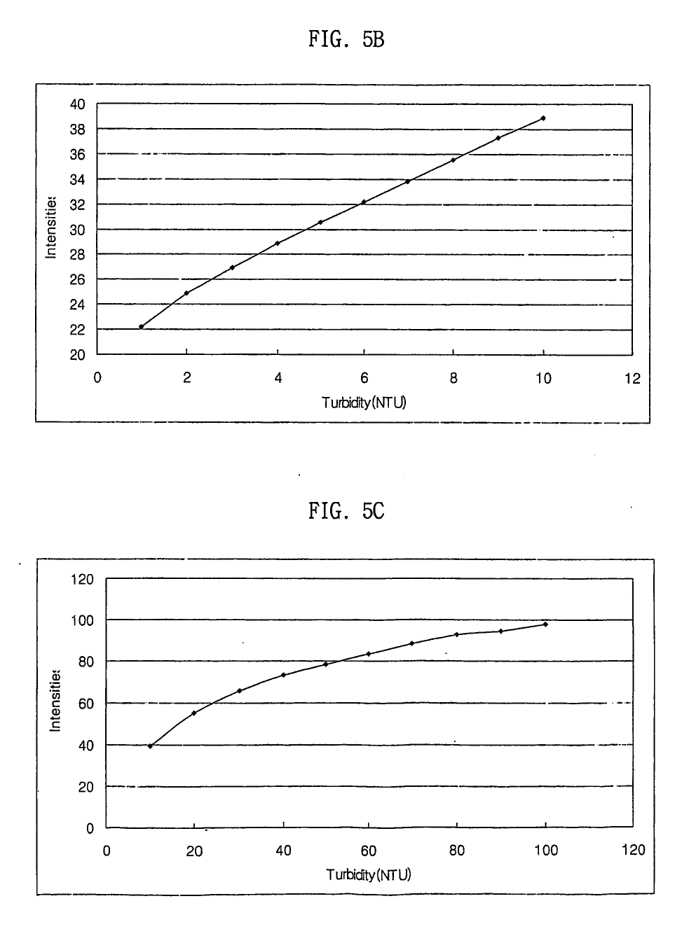

In the relational computation unit 8, a regression analysis method, optimization technique, artificial neuron system, fuzzy, neuron fuzzy, etc. may be used for a relational computation algorithm used when comparing the sample and the standard sample. In particular, in the relational computation unit, the comparison method is directed to measuring the number of the red, green and blue pixels included in the image data of the image photographed by the photographing unit, comparing the measured value with the R, G, B values set as the image data of the previously stored standard sample and then searching a standard sample having the same R, G, B values. For example, the intensities contained in the image data obtained by photographing the standard samples and averaging the same are constant in 0.1NTU˜1.0NTU as shown in FIG. 4A, and are constant in 1.0NTU˜10.0NTU as shown in FIG. 4B, and are constant in 10.NTU˜100.0NTU as shown in FIG. 4C. In addition, FIGS. 5A through 5C are the Calibration graphs of the relationships between the measured pixel intensity and the turbidity. As shown therein, the intensities of the pixels are linearly increased in all sections of 0.1NTU˜100.0NTU.

In addition, concerning the image data with respect to the standard sample with respect to various water qualities, a result obtained by measuring the number of the R, G, B pixels from the image data obtained by performing the multiple photographing operations multiple times under the same condition is stored in the water quality data DB 16 as a standard value. As shown in FIG. 3, the image data concerning the turbidity are stored in the turbidity data DB 20, the image data concerning the COD are stored in the COD data DB 22, and the image data concerning various ions are stored in the databases 24 through 40.

A water quality data of the sample 5 and the data concerning the operation of the water quality measuring apparatus 1 which are compared by the relational computation unit 8 are outputted by the display unit 10 on a screen such as a LCD, etc.

The operation switch unit 12 includes various switches needed for the operation of the water quality apparatus 1.

In addition, the control unit 14 is adapted to control the signals of the water quality measuring apparatus 1.

The procedures for measuring the turbidity using the water quality measuring apparatus according to an embodiment of the present invention will be described.

First, the sample 5 adapted to measure the turbidity is placed in the sample holder 2, and the cover of the sample holder 2 is closed. When the sample 5 is positioned in the sample holder 2, the power is supplied to the light source unit 4, so that the light is outputted from the light source unit 4. At this time, the light from the light source is outputted to only the sample 5 provided in the sample holder 2.

Thereafter, the sample 5 to which the light is projected is photographed using a camera of the photographing unit 6. At this time, the photographing unit 6 is installed at an angle of 90° with respect to the light source unit 4 in such a manner that the photographing unit 6 is not affected by a certain reflection light and light source except for the light projected to the sample. In particular, the interior of the light source unit 4 is fully covered from an external light for sufficiently transferring the image from the sample 5 to the photographing unit 6.

When the image of the sample 5 is photographed by the photographing unit 6, the image data of the sample is computed by the relational computation unit 8 based on a certain algorithm of a theory and technique such as a regression analysis method, optimization technique, artificial neuron system, fuzzy, neuron fuzzy, etc. The standard sample image data stored in the water quality data DB 16 and the image data of a corresponding sample are compared, and a standard sample having the same image data is selected as a water quality value of the sample 5. For example, the numbers of the R, G, B pixels are measured as the image data of the image of the sample photographed and are compared with the number of the R, G, B pixels set as the image data of the previously stored standard sample. Thereafter, the standard samples having the same number of the R, G, B pixels are searched and selected as the turbidity value of the sample.

In addition, in order to measure the water quality factors such as COD, Cr⁶⁺, F, T-P, Cl⁻, etc. of the sample, a preprocess is performed for changing the colors in connection with a reaction with a COD state of the same or a certain ion. The sample is photographed using the photographing unit, so that it is possible to check the water quality factors such as COD, Cr⁶⁺, F, T-P, Cl⁻, etc. of the sample.

In the above preprocess, in the case of COD, H₂SO₄ of 10 ml and Ag₂SO₄ of 10 ml are added to the sample, and KMnO₄ is added to the sample, and the resultant sample is heated and mixed with Na₂C₂O₄ of 10 ml, and then KMnO₄ is drop-added, so that an image that is changed to a thin pink color. In addition, In the case of Cr⁶⁺, the sample is neutralized with a sodium hydroxide (1N) or a sulfuric acid solution (1N), and then a sulfuric acid (1+9) of 3 ml is added. The resultant mixture is cooled to 15° C., and the preprocess is performed with respect to the resultant mixture for injecting a diphenylcarbazide, so that it is possible to obtain an image within a visual ray range.

In the case of F, a phenolphthalein ethylalcohol solution and a sodium hydroxide were added to the sample and are evaporated and concentrated so that the resultant mixture has a red color. Thereafter, a silicon dioxide, phosphoric acid, and perchloric acid are added and distilled. The resultant mixture is provided in a La Alizarin Complexon and is left alone for one hour. Finishing the above preprocess, it is possible to obtain an image within a visual ray range.

In the case of T-P, a Potassium Peroxodisulfate solution of 10 ml is added to a sample of 10 ml and is heated in a high pressure vapor thermal sterilizer for 30 minutes and is cooled. A mixture 20 ml of Ammonium Molybdate and ascorbic acid is added and is placed at a temperature of 20 through 40° C. for 15 minutes for thereby obtaining an image in a visual ray range. In addition, in the case of Cl⁻, the sample is neutralized with a sodium hydroxide solution or sulfuric acid solution for thereby obtaining an image in a visual ray range.

The image data of the same photographed by the above preprocess are compared with the image data of the standard samples stored in the COD data DB 22, the Cr⁶⁺ data DB 24, the F data DB 26, the T-P data DB 28, and the chlorine ion data DB 30 for thereby obtaining a water quality data of the samples.

As described above, in the water quality measuring apparatus according to the present invention, the image of the standard sample which has the accurate water quality factors such as a turbidity, COD, etc. is photographed, and the image data of R, G, B data values included in the image are formed in the database, and the image data of the sample which will be processed to know the water quality factors such as a turbidity, COD, etc. are processed with the database formed data, so that it is possible to obtain the accurate water quality states of the samples.

In the water quality measuring apparatus according to the present invention, in order to measure the water quality with respect to COD, Cr⁶⁺, F, T-P, chlorine, various ions, etc., the sample is preprocessed for a desired purpose, and the image of the sample is photographed and processed with the previously formed database, so that it is possible to accurately obtain the water quality states of the sample.

In a state that the photographing conditions such as a light intensity, projecting angle, etc. are same, the sample is photographed using the photographing apparatus, so that it is possible to obtain an accurate water quality data.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a water quality measuring apparatus capable of measuring a water quality data concerning turbidity, COD (Chemical Oxygen Demand), and various ions and displaying the measured water quality value on a screen, an apparatus for measuring water quality using an image, comprising:
a certain shaped casing capable of preventing a penetration of an external light;
a sample holder that is installed at one side of the casing for receiving a test sample therein;
a light source that is positioned near the sample holder for supplying a light;
a photographing unit adapted to photograph the light transmitted from the sample holder as an image signal;
a relational computation unit adapted to compute a relationship with an image data of the previously stored standard sample from the image data contained in the image photographed by the photographing unit based on a certain method selected among a regression analysis method, optimization technique, artificial neuron system, fuzzy, neuron fuzzy, etc. or a certain technique derived from the above methods for thereby computing a water quality of the test sample; and
a controller for controlling the flows of various data.

2. The apparatus of claim 1, wherein said photographing unit uses one or more than one light source wherein said light is selected among white color light, visible light, infrared ray, ultraviolet ray and laser.

3. The apparatus of claim 1, wherein said photographing unit is installed at an angle of about 45° through 90° with respect to the light source unit.

4. In a water quality measuring method for measuring a water quality data concerning turbidity, COD (Chemical Oxygen Demand), and various ions, a method for measuring water quality using an image, comprising:
a step for positioning a test sample at a sample holder for measuring a water quality using the test sample;
a step for transmitting light into the test sample in a state that a penetration of an external light is blocked;
a step for photographing the image of the test sample as an image;
a step for computing the image data included in the photographed image of the test sample using the image data of the previously computed and stored standard test sample and one method selected among a regression analysis method, optimization technique, artificial neuron system, fuzzy, neuron fuzzy, etc. or a certain technique derived from the above methods for thereby computing a water quality of the test sample using a result of the above computation; and
a step for computing the water quality value of the standard test sample having the same image data as the test sample as a water quality value of the test sample.

5. The method of claim 4, further comprising a pre-process step of the sample in such a manner that the sample has a certain color for measuring water quality with respect to COD and various ions of the sample.
